(19) United States
(12) Patent Application Publication
(10) Pub. No.: US 2005/0132089 A1
(43) Pub. Date: Jun. 16, 2005

(54) Directly connected low latency network and interface

(75) Inventors: Kent Bodell, Port Moody (CA); James Reinhard, Coquitlam (CA); Igor Gorodetsky, Coquitlam (CA); Josef Roehrl, Bowen Island (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Octigabay Systems Corporation, Burnaby (CA)

(21) Appl. No.: 10/788,455

(22) Filed: Mar. 1, 2004

Related U.S. Application Data
(60) Provisional application No. 60/531,999, filed on Dec. 24, 2003.
(60) Provisional application No. 60/528,774, filed on Dec. 12, 2003.

(51) Int. Cl. G06F 15/16

(52) U.S. Cl. 709/249

(57) ABSTRACT

Compute nodes in a high performance computer system are interconnected by an inter-node communication network. Each compute node has a network interface coupled directly to a CPU by a dedicated full-duplex packetized interconnect. Data may be exchanged between compute nodes using eager or rendezvous protocols. The network interfaces may include facilities to manage data transfer between computer nodes.

### REFERENCE TO RELATED APPLICATION

This application claims the benefit under 35 U.S.C. §119 of U.S. patent application Nos. 60/528,774 entitled “DIRECTLY CONNECTED LOW LATENCY NETWORK”, filed 12 Dec. 2003 and 60/531,999 entitled “LOW LATENCY NETWORK WITH DIRECTLY CONNECTED INTERFACE”, filed 24 Dec. 2003.

### TECHNICAL FIELD

This invention relates to multiprocessor computer systems. In particular, the invention relates to communication networks for exchanging data between processors in multiprocessor computer systems.

### BACKGROUND

Multiprocessor, high performance computers (e.g. supercomputers) are often used to solve large complex problems. FIG. 1 shows schematically a multiprocessor computer 10 having compute nodes 20 connected by a communication network 30. Software applications running on such computers split large problems up into smaller sub-problems. Each sub-problem is assigned to one of compute nodes 20. A program is executed on one or more CPUs of each compute node 20 to solve the sub-problem assigned to that compute node 20. The program run on each compute node has one or more processes. Executing each process involves executing a sequence of software instructions. All of the processes execute concurrently and may communicate with each other.

Some problems cannot be split up into sub-problems which are independent of other sub-problems. In such cases, to solve at least some of the sub-problems, an application process must communicate with other application processes that are solving related sub-problems to exchange intermediate results. The application processes cooperate with each other to obtain a solution to the problem.

Communication between processes solving related sub-problems often requires the repeated exchange of data. Such data exchanges occur frequently in high performance computers. Communication performance in terms of bandwidth, and especially latency, are a concern. Overall application performance is, in many cases, strongly dependent on communication latency.

Communication latency has three major components:
the latency to transfer a data packet from a CPU or other device in a sending compute node to a communication network;
the latency to transfer a data packet across the communication network; and,
the latency to transfer a data packet from the communication network to a device such as a CPU in a receiving compute node.

In order to reduce latency, various topologies (e.g. hypercube, mesh, toroid, fat tree) have been proposed and/or used for interconnecting compute nodes in computer systems. These topologies may be selected to take advantage of communication patterns expected for certain types of high performance applications. These topologies often require that individual compute nodes be directly connected to multiple other compute nodes.

Continuous advances have been made over the years in communication network technology. State of the art communication networks have extremely high bandwidth and very low latency. The inventors have determined that available communication network technology is not necessarily a limiting factor in improving the performance of high performance computers as it once was. Instead, the performance of such computers is often limited by currently accepted techniques used to transfer data between CPUs and associated network interfaces and the network interfaces themselves. The following description explains various existing computer architectures and provides the inventors' comments on some of their shortcomings for use in high performance computing.

FIG. 2 shows how early computers, and even some modern computers, support data communication. A CPU 100 is connected to memory and peripherals using an address and data bus 160. Address and data bus 160 combines a parallel address bus and a parallel data bus. Memory 110, video display interface 120, disk interface 130, network interface 140, keyboard interface 150, and any other peripherals are each connected to address and data bus 160. Bus 160 is shared for all communication between CPU 100 and all other devices in the computer. Bandwidth and latency between CPU 100 and network interface 140 are degraded because network interface 140 must compete with memory and all the other peripherals for use of bus 160. Further, hardware design considerations limit the rate at which data can be carried over an address and data bus.

CPU speeds have increased over the years. It is increasingly difficult to directly interface high-speed CPUs to low-speed peripherals. This led to the computer architecture shown in FIG. 3 in which CPU 200 is connected by a high-speed front side bus (FSB) 240 to north bridge chip 230. North bridge 230 provides an interface to memory 210 and to high-speed peripherals such as video display interface 220. In modern personal computers, an AGP interface is used between north bridge 230 and video display interface 220. A variety of interfaces (e.g. SDRAM, DDR, RAMBUS™) have been used to interface memory 210 to north bridge 230.

Low-speed peripherals such as keyboard 250, mouse 260, and disk 270 are connected to south bridge chip 280. South bridge 280 is connected to north bridge 230 via a medium- to high-speed bus 290. South bridge 280 will often support an I/O bus 310 (e.g. ISA, PCI, PCI-X) to which peripheral cards can be connected. Network interfaces (e.g. 300) are connected to I/O bus 310.

Some vendors have implemented I/O bus 310 in north bridge 230 instead of south bridge 280 and some have used I/O bus technology for both bus 310 and bus 290.

Modern designs involving north bridges and south bridges are still very poor for high performance data communication. While the north bridge can accommodate higher speed FSB 240, network interface 300 shares FSB 240 with memory 210 and all other peripherals. In addition, network traffic must now traverse both north bridge 230 and south bridge 280. I/O bus 310 is still shared between network interface 300 and any other add-in peripheral cards.

Some designs exacerbate the above problems. These designs connect more than one CPU 200 (e.g. two or four) to FSB 240 to create two-way or four-way shared memory processors (SMPs). All of the CPUs must contend for FSB 240 in order to access shared memory 210 and other peripherals.

Another limitation of existing architectures is that there are technical impediments to significantly increasing the speed at which front side buses operate. These buses typically include address and data buses each consisting of many signal lines operating in parallel. As speed increases, signal skew and crosstalk reduce the distance that these buses can traverse to a few inches. Signal reflections from terminations on multiple CPUs and the north bridge adversely affect bus signal quality.

A few vendors (e.g. AMD and Motorola) have started to make CPUs having parallel interconnects which have a reduced number of signal lines (reduced-parallel interconnects) or serial system interconnects. These interconnects use fewer signal lines than parallel address and data buses, careful matching of signal line lengths, and other improvements to drive signals further at higher speeds than can be readily provided using traditional FSB architectures. Current high performance interconnects typically use Low Voltage Differential Signaling (LVDS) to achieve higher data rates and reduced electromagnetic interference (EMI). These interconnects are configured as properly terminated point-to-point links and are not shared in order to avoid signal reflections. Such serial and reduced-parallel interconnects typically operate at data rates that exceed 300 MBps (megabytes per second).

Examples of such interconnects include HyperTransport™, RapidIO™, and PCI Express. Information about these interconnects can be found at various sources including the following:
HyperTransport I/O Link Specification, HyperTransport Consortium, http://www.hypertransport.org/
RapidIO Interconnect Specification, RapidIO Trade Association, http://www.rapidio.org/
RapidIO Interconnect GSM Logical Specification, RapidIO Trade Association, http://www.rapidio.org/
RapidIO Serial Physical Layer Specification, RapidIO Trade Association, http://www.rapidio.org/
RapidIO System and Device Inter-operability Specification, RapidIO Trade Association, http://www.rapidio.org/
PCI Express Base Specification, PCI-SIG, http://www.pcisig.com/
PCI Express Card Electromechanical Specification, PCI-SIG, http://www.pcisig.com/
PCI Express Mini Card Specification, PCI-SIG, http://www.pcisig.com/

Because the number of signal lines in a serial or reduced-parallel interconnect is less than the width of data being transferred, it is not possible to transfer data over such interconnects in a single clock cycle. Instead, both serial and reduced-parallel interconnects package and transfer data in the form of packets.

These interconnects can be operated using protocols which use memory access semantics. Memory access semantics associate a source or destination of data with an address which can be included in a packet. Read request packets contain an address and number of bytes to be fetched. Read response packets return the requested data. Write request packets contain an address and data to be written. Write confirmation packets optionally acknowledge the completion of a write. The internal structure of individual packets, the protocols for exchanging packets and the terminology used to describe packets differ between the various packetized interconnect technologies.

Interconnects which use memory access semantics including packetized parallel interconnects having a number of signal lines which is smaller than a width of data words being transferred and packetized serial interconnects are referred to collectively herein as “packetized interconnects”. The term “packetized interconnects” has been coined specifically for use in this disclosure and is not defined by any existing usage in the field of this invention. For example, packetized interconnect is not used herein to refer to packet-based data communication protocols (e.g. TCP/IP) that do not use memory access semantics.

An important side effect of using an interconnect which has a reduced number of signal lines is that it is possible to connect multiple packetized interconnects to one CPU. For example, one model of AMD Opteron™ CPU terminates three instances of a packetized interconnect (i.e. HyperTransport™). A few CPUs (e.g. the AMD Opteron™) combine the use of packetized interconnects with a traditional address and data bus which is used for access to main memory.

The computer architecture of FIG. 4 uses a CPU which connects to peripherals by a packetized interconnect. CPU 420 is directly connected to memory 400 by a traditional, parallel, address and data bus 410. CPU 420 is directly connected to a video display interface 430, a south bridge 440, and an I/O interface 450 via packetized interconnects 460. Keyboard 480 and mouse 490 are connected to south bridge 440. I/O interface 450 connects packetized interconnect 460 to a traditional I/O bus 510 (e.g. PCI, PCI-X). Network interface 500 is connected to I/O bus 510.

The architecture of FIG. 4 provides some benefits relative to earlier architectures. Peripheral cards such as network interface 500 no longer have to share a FSB with memory. They have exclusive use of one instance of packetized interconnect 460 to communicate with CPU 420. The inventors have recognized that the architecture of FIG. 4 still has the following problems:
Network interface 500 must share I/O bus 510 with all other add-in peripheral cards; and,
Latency is increased because data passing in either direction between CPU 420 and network interface 500 must traverse I/O interface 450.

Despite the various architectural improvements, the aforementioned architectures still have a serious problem with regards to the high bandwidth, low latency data communication that is required by high performance computer systems. Data packets are forced to traverse a traditional I/O bus 510 in the process of being transferred between CPU 420 and network interface 500. Because bus 510 uses a common address and data bus to transfer data back and forth between devices, bus 510 operates in half duplex mode. Only one device can transfer data at a time (e.g. network interface 500 to I/O interface 450 or I/O interface 450 to network interface 500). In contrast, packetized interconnects and most modern communication network data links operate in full duplex mode with separate transmit and receive signal lines.

In FIG. 5, which corresponds to the architecture shown in FIG. 4, it can be seen that I/O interface 450 must convert between full-duplex packetized interconnect 460 and half-duplex I/O bus 510. Similarly, network interface 500 must convert between half-duplex I/O bus 510 and full-duplex communication data link 520. Converting between half-duplex and full-duplex transmission decreases communication performance. Unless the half-duplex bandwidth of bus 510 is equal to or greater than the sum of the bandwidth in each direction on interconnect 460, the full bandwidth of interconnect 460 cannot be utilized. Similar reasoning shows that the full bandwidth of communication link 520 cannot be exploited unless the half-duplex bandwidth of bus 510 is equal to or greater than the sum of the bandwidth in each direction on communication link 520.

As an example, if HyperTransport™ is used to implement packetized interconnect 460, it can be operated at a rate of 25.6 Gbps (Gigabits per second) in each direction for an aggregate bi-directional bandwidth of 51.2 Gbps. Similarly, if InfiniBand™ 4X or 10GigE technology were used to implement data link 520, the data link could support a bandwidth of 10 Gbps in each direction for an aggregate bi-directional bandwidth of 20 Gbps. In contrast, 64 bit wide PCI-X operating at 133 MHz can only support a half duplex bandwidth of 8.5 Gbps. In this example the PCI-X I/O bus provides a bottleneck.

Because I/O bus 510 can only transmit in one direction at a time, packets may have to be queued in either I/O interface 450 or network interface 500 until bus 510 can be reversed to support communication in the desired direction. This can increase latency unacceptably for some applications. For example, consider a packet with a size of 1000 bytes that is being transferred from network interface 500 over a PCI-X bus 510 having the aforementioned characteristics to I/O interface 450. If a packet arrives at I/O interface 450 from CPU 420, it may be necessary to queue the packet at I/O interface 450 for up to 0.94 microseconds.

High performance computers can ideally transfer a data packet from a CPU in one compute node to a CPU in another compute node in 3 microseconds or less. Where a 1000 byte packet has to be queued to use the half duplex I/O bus in each compute node, it is conceivable that as much as 1.88 microseconds might be spent waiting. This leaves very little time for any other communication delays. Moving beyond the status quo, high performance computing would benefit greatly if communication latencies could be reduced from 3 microseconds to 1 microsecond or better.

Network interfaces present other problem areas. As speeds of data communication networks have increased there has been a trend to move away from copper-based cabling to optical fibers. For example, copper-based cabling is used for 10 Mbps (megabits per second), 100 Mbps, and 1 Gbps Ethernet. In contrast, 10 Gbps Ethernet currently requires optical fiber-based cabling. A single high performance computer system may require a large number of cables. As an example, a product under development by the inventors terminates up to 24 data links. The product can be configured in various ways. For example, the product may used to construct a 1000 compute node high performance computer with a fat tree topology communication network. Some configurations use up to 48,000 connections between different compute nodes. If a separate cable were used for each connection then 48,000 cables would be required. The cost of cables alone can be significant.

Optical fiber-based cabling is currently significantly more expensive than copper-based cabling. Network interface terminations for optical fiber-based cabling are currently significantly more expensive than terminations for copper-based cabling. As mentioned previously, high performance computers often have to terminate multiple communication network data links. Providing cables and terminations for large numbers of optical fiber-based data links can be undesirably expensive.

Of the few high speed communication network technologies that use copper-based cabling, most are undesirably complicated for high performance computing. These technologies have been implemented to satisfy the wide variety of requirements imposed by enterprise data centers.

One such communication network technology is InfiniBand™. InfiniBand™ was developed for use in connecting computers to storage devices. Since then it has evolved, and its feature set has expanded. InfiniBand™ is now a very complicated, feature rich technology. Unfortunately, InfiniBand™ technology is so complex that it is ill suited for use in communication networks in high performance computing. Ohio State University discovered that a test communication network based on InfiniBand™ had a latency of 7 microseconds. While technical improvements can reduce this latency, it is too large for use in high performance computing.

There remains a need in the supercomputing field for a cost effective and practical communication network technology that provides dedicated high bandwidth, and low latency.

### BRIEF DESCRIPTION OF THE DRAWINGS

In drawings which illustrate non-limiting embodiments of the invention:

FIG. 1 is a schematic illustration of the architecture of a prior art multiprocessor computer system;

FIG. 2 is a block diagram illustrating the architecture of early and certain modern prior art personal computers;

FIG. 3 is a block diagram illustrating the architecture of most modern prior art personal computers;

FIG. 4 is a block diagram illustrating an architecture of a state-of-the-art personal computer having CPUs connected to other devices by packetized interconnects;

FIG. 5 is a block diagram illustrating a data communication path in a state of the art computer system having a CPU connected to other devices by a packetized interconnect;

FIG. 6 is a block diagram illustrating a computer system according to an embodiment of the invention having a network interface directly connected to a CPU via a packetized interconnect dedicated to data communication;

FIG. 7 is a block diagram illustrating a data communication path in a compute node that implements the invention;

FIG. 8 is a diagram illustrating layers in a communication protocol; and,

FIGS. 9 and 10 are block diagrams illustrating data communication paths in a computer system according to the invention; and,

FIGS. 11 to 13 illustrate a network interface.

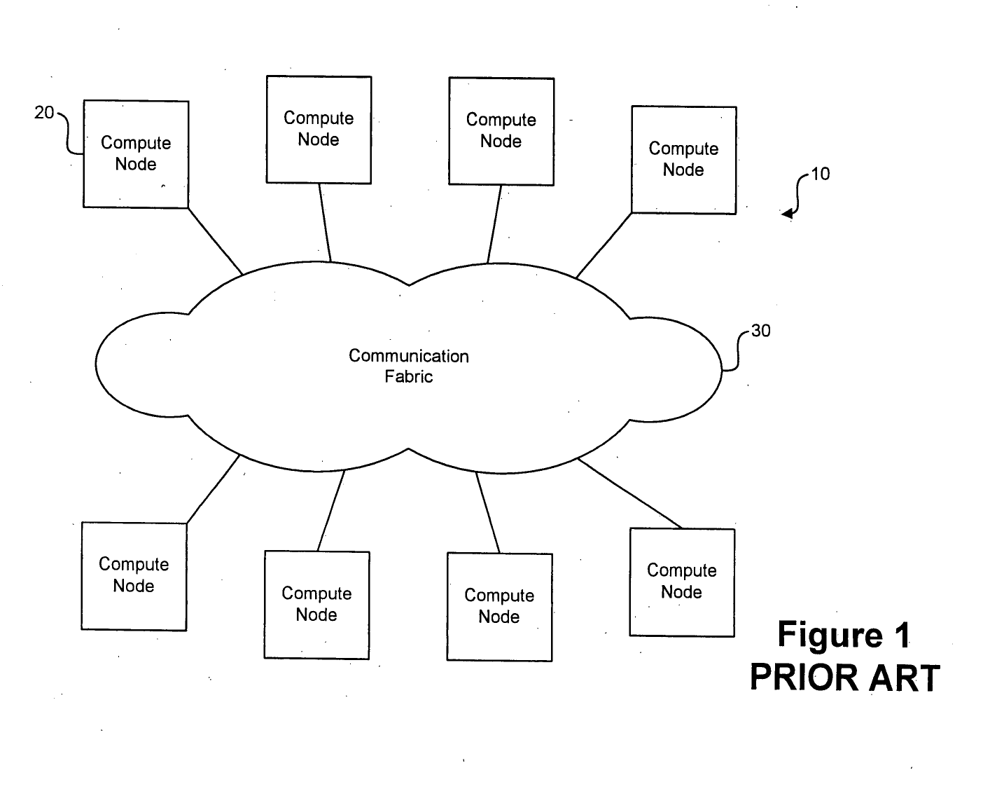

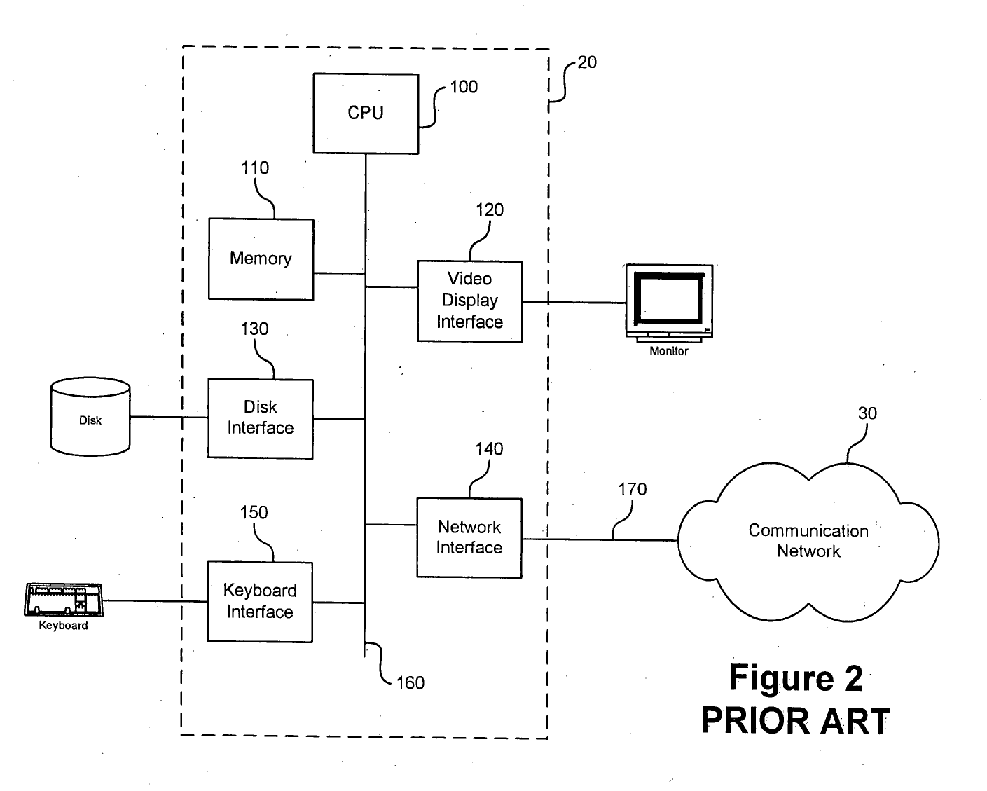

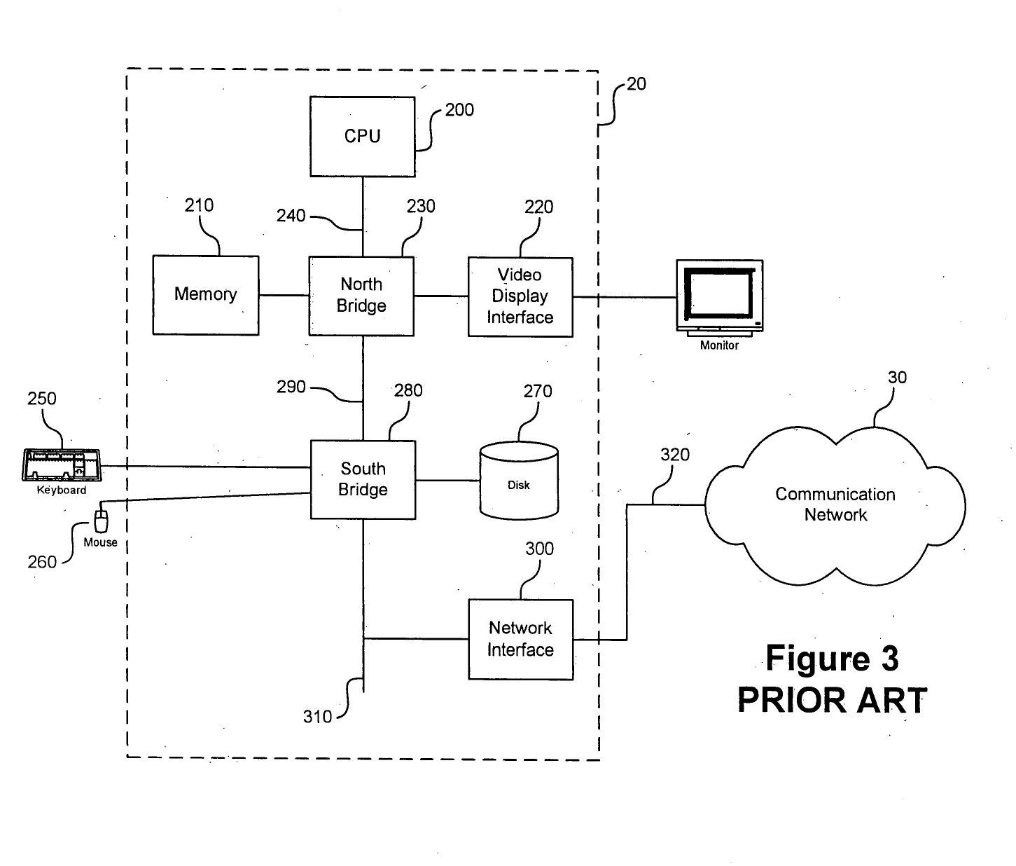

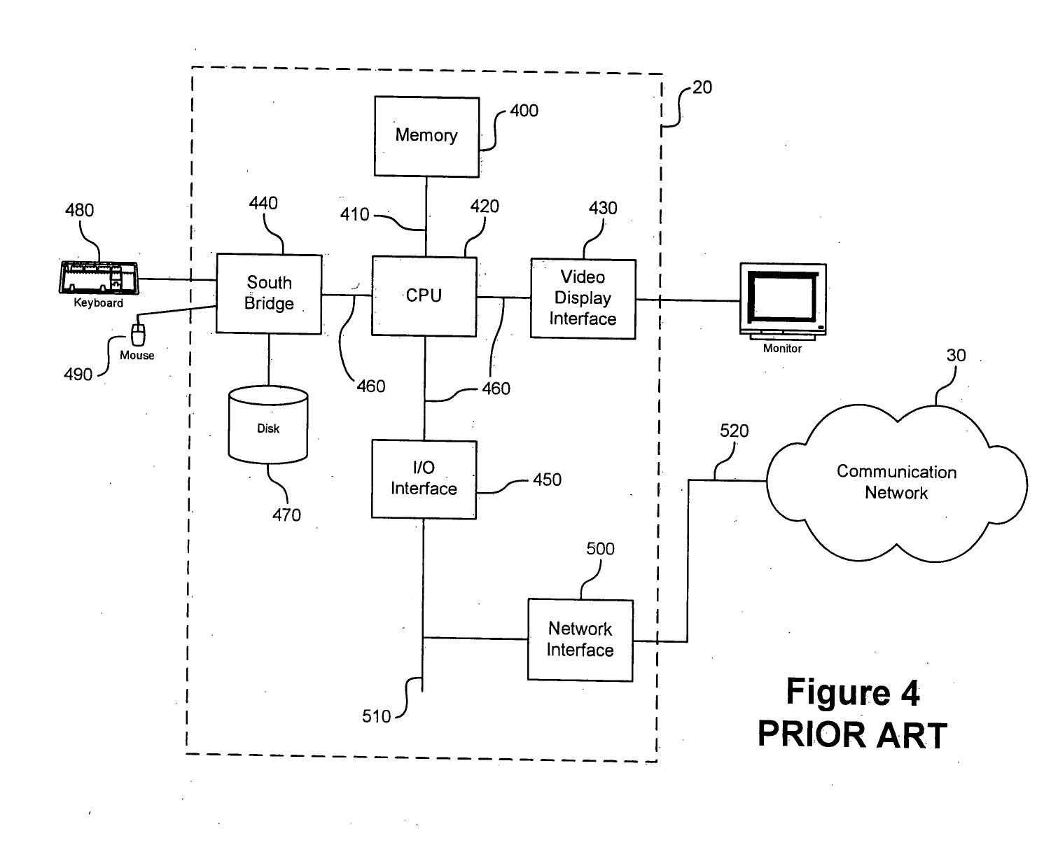

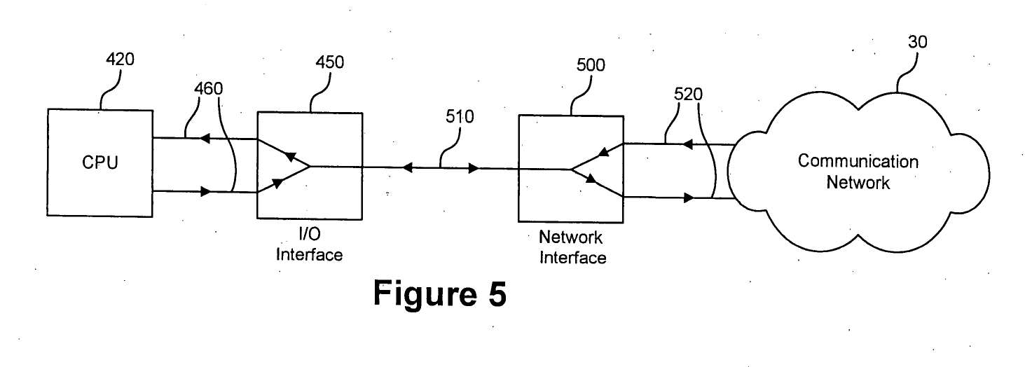

Various aspects of the invention and features of specific embodiments of the invention are described below.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

This invention exploits the packetized interconnects as provided, for example, by certain state of the art CPUs to achieve low latency data communication between CPUs in different compute nodes of a computer system. A CPU has at least one packetized interconnect dedicated to data communication. This provides guaranteed bandwidth for data communication. A network interface is attached directly to the CPU via the dedicated packetized interconnect. Preferably the packetized interconnect and a communication data link to which the network interface couples the packetized interconnect both operate in a full-duplex mode.

In some embodiments of the invention the communication network uses a communication protocol based on InfiniBand™. In some cases the communication protocol is a simplified communication protocol which uses standard InfiniBand™ layers 1 and 2. A high-performance computing-specific protocol replaces InfiniBand™ layers 3 and above.

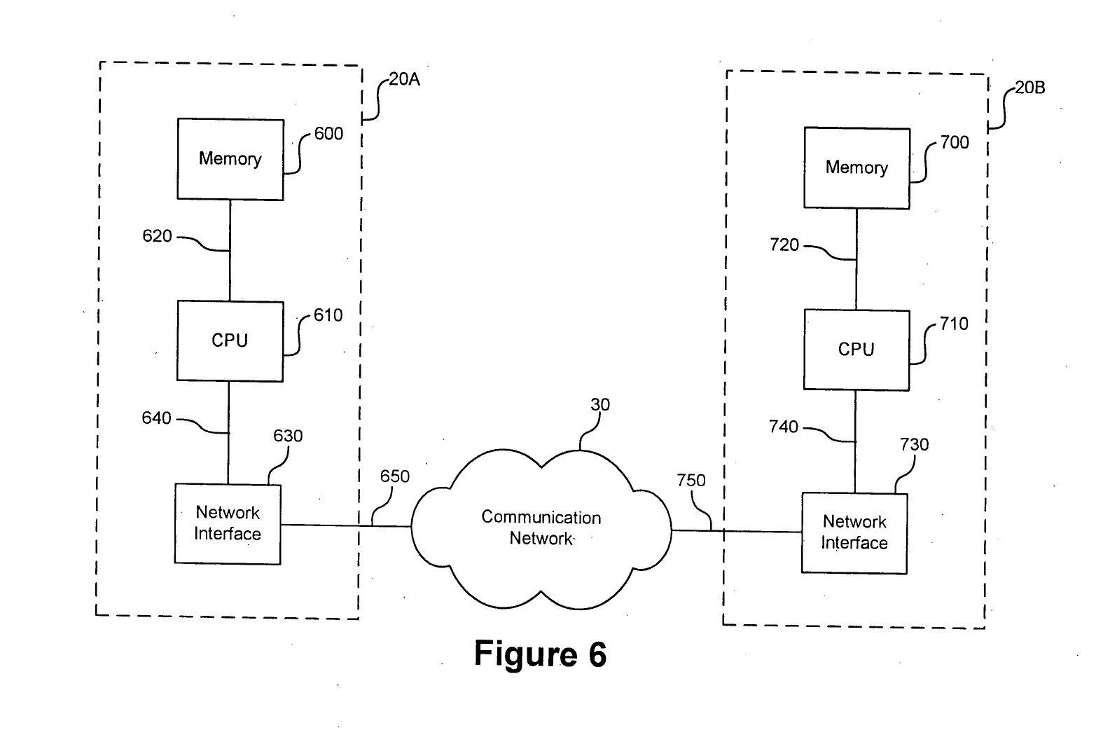

A computer system according to a preferred embodiment of the invention is shown in FIG. 6. FIG. 6 shows only 2 compute nodes 20A and 20B (collectively compute nodes 20) for simplicity. A computer system according to the invention may have more than two compute nodes. Computer systems according to some embodiments of the invention have 100 or more compute nodes. Computer systems according to the invention may have 500 or more, 1000 or more, or 5,000 or more compute nodes. Some advantages of the invention are fully realized in computer systems having many (i.e. 100 or more) interconnected compute nodes.

CPU 610 is connected to memory 600 using interconnect 620. Interconnect 620 may comprise a traditional parallel address and data bus, a packetized interconnect or any other suitable data path which allows CPU 610 to send data to or receive data from memory 600. Memory 600 may include a separate memory controller or may be controlled by a controller which is integrated with CPU 610. A packetized interconnect 640 attached to CPU 610 is dedicated to data communication between CPU 610 and a network interface 630. Apart from CPU 610 and network interface 630, no device which consumes a significant share of the bandwidth of packetized interconnect 640 or injects traffic sufficient to increase latency of interconnect 640 to any significant degree shares packetized interconnect 640. In this case, a significant share of bandwidth is 5% or more and a significant increase in latency is 5% or more. In preferred embodiments of the invention no other device shares packetized interconnect 640.

Network interface 630 is directly attached to CPU 610 via packetized interconnect 640. No gateway or bridge chips are interposed between CPU 610 and network interface 630. The lack of any gateway or bridge chips reduces latency since such chips, when present, take time to transfer packets and to convert the packets between protocols.

Packetized interconnect 640 extends the address space of CPU 610 out to network interface 630. CPU 610 uses memory access semantics to interact with network interface 630. This provides an efficient mechanism for CPU 610 to interact with network interface 630.

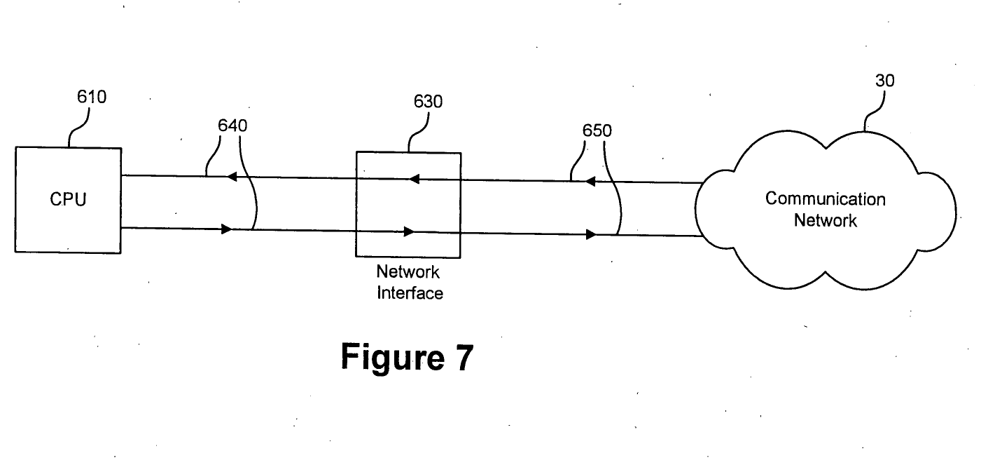

Referring now to FIG. 7 which corresponds to the architecture shown in FIG. 6, full duplex packetized interconnect 640 is directly interfaced to full duplex communication data link 650. The receive signal lines of interconnect 640 (relative to network interface 630) are interfaced to the transmit signal lines of data link 650. Similarly, the receive signal lines of data link 650 are interfaced to the transmit signal lines of interconnect 640.

Since network interface 630 directly connects the two full duplex links 640 and 650 together, interface 630 can be constructed so that there is no bandwidth bottleneck. If communication data link 650 is slower than packetized interconnect 640, the full bandwidth of link 650 can be utilized. If packetized interconnect 640 were slower instead, the full bandwidth of interconnect 640 could be utilized.

Directly connecting full duplex links 640 and 650 together also eliminates queuing points as would be required at a transition between full duplex and half duplex technologies. This eliminates a major source of latency. The only queuing point that remains is the transition from the faster technology to the slower technology. For example, if packetized interconnect 640 is faster than communication data link 650, a queuing point is provided in the direction and at the location in network interface 630 where outgoing data packets are transferred from packetized interconnect 640 to data link 650. Such a queuing point handles the different speeds and bursts of data packets. If the two technologies implement flow control, packets will not normally queue at this queuing point.

In embodiments of the invention wherein packetized interconnect 640 and communication data link 650 are both full-duplex network interface 630 can be simplified. In such embodiments network interface 630 need only transform packets from the packetized interconnect protocol to the communication data link protocol and vice versa in the other direction. No functionality need be included to handle access contention for a half duplex bus. As mentioned above, queuing can be removed in one direction. Simple protocols may be used to manage the flow of data between CPU 610 and communication network 30. The result of these simplifications is that network interface 630 is less expensive to implement and both latency and bandwidth can be further improved.

A single CPU can be connected to multiple network interfaces 630. If multiple packetized interconnects 640 are terminated on a single CPU and are available, each such packetized interconnect 640 may be dedicated to a different network interface 630. A compute node may include multiple CPUs which may each be connected to one or more network interfaces by one or more packetized interconnects. If network interface 630 is capable of handling the capacity of multiple packetized interconnects, it may terminate multiple packetized interconnects 640 originating from one or more CPUs.

It will usually be the case that packetized interconnect 640 is faster than communication data link 650. The shorter distances traversed by packetized interconnects allow higher clock speeds to be achieved. If the speed of a packetized interconnect 640 is at least some multiple N, of the speed of a data link 650 (where N is an integer and N>1), network interface 630 can terminate up to N communication data links. Even if a packetized interconnect 640 is somewhat less than N times faster than a communication data link 650, network interface 630 could still terminate N communication data links with little risk that packetized interconnect 640 will be unable to handle all of the traffic to and from the N communication data links. There is a high degree of probability that not all of the communication data links will be simultaneously fully utilized.

Network interface 630 preferably interfaces packetized interconnect 640 to a communication protocol on data link 650 that is well adapted for high performance computing (HPC). Preferred embodiments of the invention use a communication protocol that supports copper-based cabling to lower the cost of implementation.

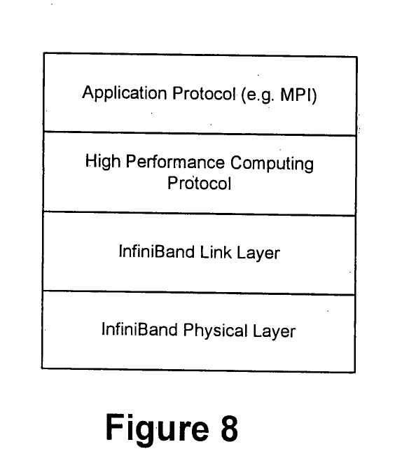

FIG. 8 shows a protocol stack for a HPC communication protocol that is used in some embodiments of the invention. The communication protocol uses the physical layer and link layer from InfiniBand™. The complex upper layers of InfiniBand™ are replaced by a special-purpose protocol layer designated as the HPC layer. The HPC layer supports an HPC protocol. One or more application protocols use the HPC protocol. Examples of application protocols include MPI, PVM, SHMEM, and global arrays.

The InfiniBand™ physical layer supports copper-based cabling. Optical fiber-based cabling may also be supported. Full duplex transmission separates transmit data from receive data. LVDS and a limited number of signaling lines (to improve skew, etc.) provide high speed communication.

The InfiniBand™ link layer supports packetization of data, source and destination addressing, and switching. Where communication links 650 implement the standard InfiniBand™ link layer, commercially available InfiniBand™ switches may be used in communication network 30. In some embodiments of the invention the link layer supports packet corruption detection using cyclic redundancy checks (CRCs). The link layer supports some capability to prioritize packets. The link layer provides flow control to throttle the packet sending rate of a sender.

The HPC protocol layer is supported in an InfiniBand™ standard-compliant manner by encapsulating HPC protocol layer packets within link layer packet headers. The HPC protocol layer packets may, for example, comprise raw ethertype datagrams, raw IPv6 datagrams, or any other suitable arrangement of data capable of being carried within a link layer packet and of communicating HPC protocol layer information.

The HPC protocol layer supports messages (application protocol layer packets) of varying lengths. Messages may fit entirely within a single link layer packet. Longer messages may be split across two or more link layer packets. The HPC protocol layer automatically segments messages into link layer packets in order to adhere to the Maximum Transmission Unit (MTU) size of the link layer.

The HPC protocol layer directly implements eager and rendezvous protocols for exchanging messages between sender and receiver. Uses of eager and rendezvous protocols in other contexts are known to those skilled in the art. Therefore, only summary explanations of these protocols are provided here.

The eager protocol is used for short messages and the rendezvous protocol is used for longer messages. Use of the eager or rendezvous protocol is not necessarily related to whether a message will fit in a single link layer packet. By implementing eager and rendevous protocols in the HPC protocol layer, a higher degree of optimization can be achieved. Some embodiments of the invention provide hardware acceleration of the eager and/or rendevous protocols.

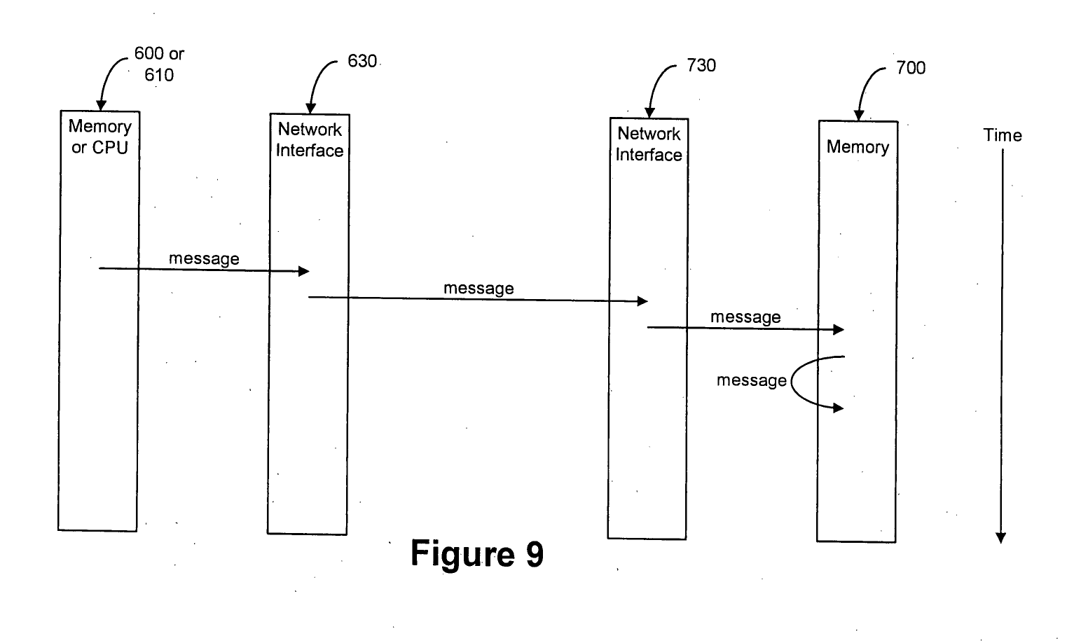

FIG. 9 shows the flow of messages in an eager protocol transaction. A sender launches a message toward a receiver without waiting to see if a receiving application process has a buffer to receive the message. The receiving network interface receives the message and directs the message to a separate set of buffers reserved for the eager protocol. These are referred to herein as eager protocol buffers. When the receiving application process indicates it is ready to receive a message and supplies a buffer, the previously-received message is copied from the eager protocol buffer to the supplied application buffer.

As an optimization, the receiving network interface may send the received message directly to a supplied application buffer, bypassing the eager protocol buffers, if the receiving application has previously indicated that it is ready to receive a message. The eager protocol has the disadvantage of requiring a memory-to-memory copy for at least some messages. This is compensated for by the fact that no overhead is incurred in maintaining coordination between sender and receiver.

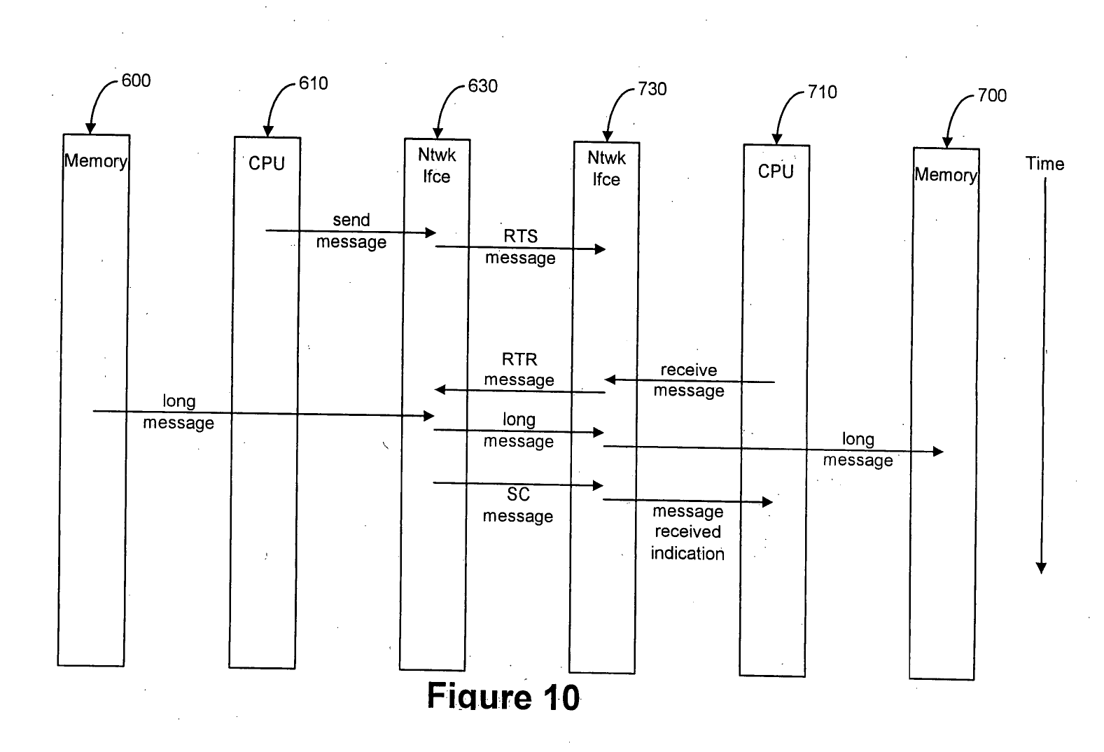

FIG. 10 shows how the rendezvous protocol is used to transmit a long message directly between buffers of the sending and receiving application processes. A sending application running on CPU 610 instructs network interface 630 to send a message and provides the size of the message and its location in memory 600. Network interface 630 sends a short Ready-To-Send (RTS) message to network interface 730 indicating it wants to send a message. When the receiving application process running on CPU 710 is ready to receive a message, it informs network interface 730 that it is ready to receive a message. In response, network interface 730 processes the Ready-To-Send message and returns a short Ready-To-Receive (RTR) message indicating that network interface 630 can proceed to send the message. The RTR message provides the location and the size of an empty message buffer in memory 700. Network interface 630 reads the long message from memory 600 and transmits the message to network interface 730. Network interface 730 transfers the received long message to memory 700 directly into the application buffer supplied by the receiving application.

When network interface 630 has completed sending the long message, it sends a short Sending-Complete (SC) message to network interface 730. Network interface 730 indicates that a message has been received to the receiving application running in CPU 710. The Ready-To-Send, Ready-To-Receive, and Sending-Complete messages may be transferred using the eager protocol and are preferably generated automatically and processed by network interfaces 630 and 730. As a less preferable alternative, software running on CPUs 610 and 710 can control the generation and processing of these messages. The rendezvous protocol has the disadvantage of requiring three extra short messages to be sent, but it avoids the memory-to-memory copying of messages.

size of the message and its location in memory 600. Network interface 630 sends a short Ready-To-Send (RTS) message to network interface 730 indicating it wants to send a message. When the receiving application process running on CPU 710 is ready to receive a message, it informs network interface 730 network interface 730 that it is ready to receive a message. In response network interface 730 processes the Ready-To-Send message and returns a short Ready-To-Receive (RTR) message indicating that network interface 630 can proceed to send the message. The RTR message provides the location and the size of an empty message buffer in memory 700. Network interface 630 reads the long message from memory 600 and transmits the message to network interface 730. Network interface 730 transfers the received long message to memory 700 directly into the application buffer supplied by the receiving application.

When network interface 630 has completed sending the long message, it sends a short Sending-Complete (SC) message to network interface 730. Network interface 730 indicates that a message has been received to the receiving application running in CPU 710. The Ready-To-Send, Ready-To-Receive, and Sending-Complete messages may be transferred using the eager protocol and are preferably generated automatically and processed by network interfaces 630 and 730. As a less preferable alternative, software running on CPUs 610 and 710 can control the generation and processing of these messages. The rendezvous protocol has the disadvantage of requiring three extra short messages to be sent, but it avoids the memory-to-memory copying of messages.

HPC communication should ideally be readily scalable to tens of thousands of CPUs engaged in all-to-all communication patterns. Conventional transport layer protocols (e.g. the InfiniBand™ transport layer) do not scale well to the number of connections desired in high performance computer systems. In such transport layer protocols, each connection has an elaborate state. Each message must pass through work queues (queue pairs in InfiniBand™). Elaborate processing is required to advance the connection state. This leads to excessive memory and CPU time consumption.

The HPC protocol layer may use a simplified connection management scheme that takes advantage of direct support for the eager and rendezvous protocols. Each receiver allocates a set of eager protocol buffers. During connection establishment, a reference to the allocated set of eager protocol buffers is provided by the receiver to the sender. The sender references these buffers in any eager protocol messages in order to direct the message to the correct receiving application process. Since the eager protocol is also used to coordinate the transfer of messages by the rendezvous protocol, it is unnecessary for the connection to be used to manage the large rendezvous protocol messages.

As a variant, it is possible for a single larger set of eager protocol buffers to be shared by a single receiving application amongst multiple connections. In such embodiments each connection would require a control data structure to record the identities of the buffers associated with the connection. This variant reduces the memory usage further at the receiver, but incurs extra processing overhead.

Conventional transport layer protocols support reliable transport of messages separately for each connection. This adds to the connection state information. In contrast, the HPC protocol layer supports reliable transport between pairs of CPUs. All connections between a given pair of CPUs share the same reliable transport mechanism and state information. Like conventional transport layer protocols, the HPC reliable transport mechanism is based on acknowledgment of successfully received messages and retransmission of lost or damaged messages.

Memory protection keys may be used to protect the receiver's memory from being overwritten by an erroneous or malicious sender. The memory protection key incorporates a binary value that is associated with that part of the receiver's memory which contains message buffers for received messages. During connection setup, a memory protection key corresponding to the set of eager protocol buffers is provided to the sender. Memory protection keys may thereafter be provided to the sender for the message buffers supplied by the receiving application for rendezvous protocol long messages. A sender must provide a memory protection key with each message. The receiving network interface verifies the memory protection key against the targeted message buffers before writing the message into the buffer(s). The generation and verification of memory protection keys may be performed automatically.

Network interface 630 implements the functions of terminating a packetized interconnect, terminating a communication protocol, and converting packets between the packetized interconnect and communication network technologies.

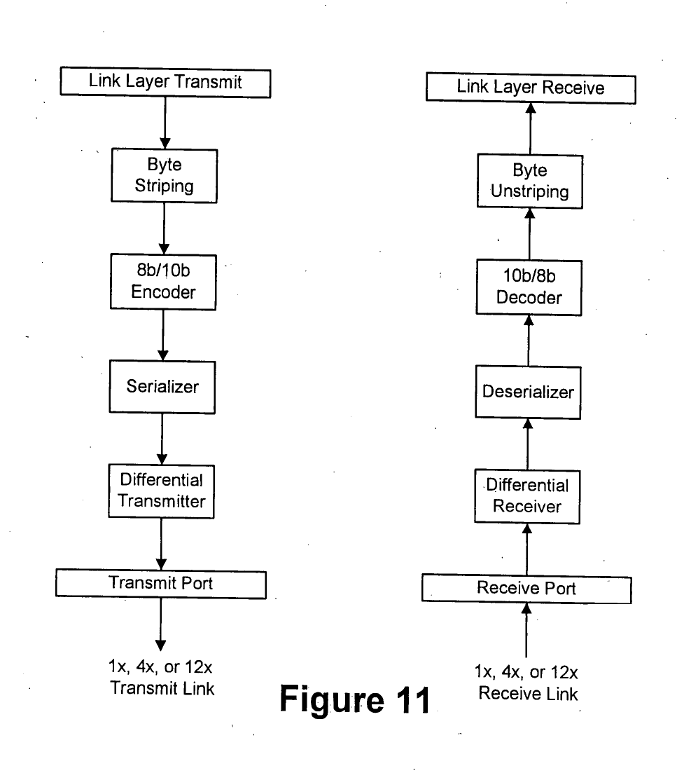

For example, in a specific embodiment, network interface 630 implements the physical layer of InfiniBand™ (see FIG. 11) by terminating an InfiniBand™ 1X, 4X, or 12X data link. For copper-based cabling, the data link carries data respectively over sets of 1, 4, or 12 sets (lanes) of four wires. Within a set of four wires, two wires form a transmit LVDS pair and two wires form a receive LVDS pair.

Network interface 630 may also byte stripe all data to be transmitted across the available lanes, pass data through an encoder (e.g. an 8 bit to 10 bit (8b/10b) encoder), serialize the data, and transmit the data by the differential transmitter using suitable encoding (e.g. NRZ encoding). All data is received by a differential receiver, de-serialized, passed through a 10 bit to 8 bit decoder, and un-striped from the available data lanes.

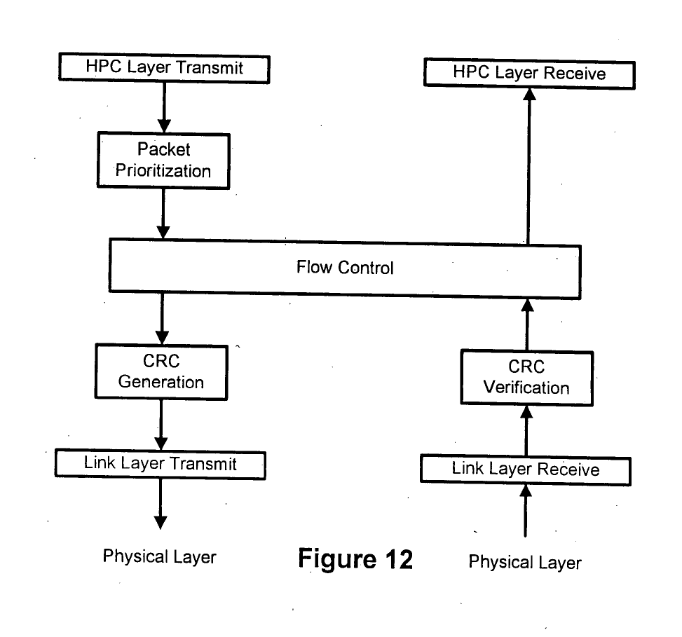

Network interface 630 implements the link layer of InfiniBand™ (see FIG. 12). Network interface 630 may prioritize, packets prior to transmission. Flow control prevents packets from overflowing the buffers of receiving network interfaces. A CRC is generated prior to transmission and verified upon receipt.

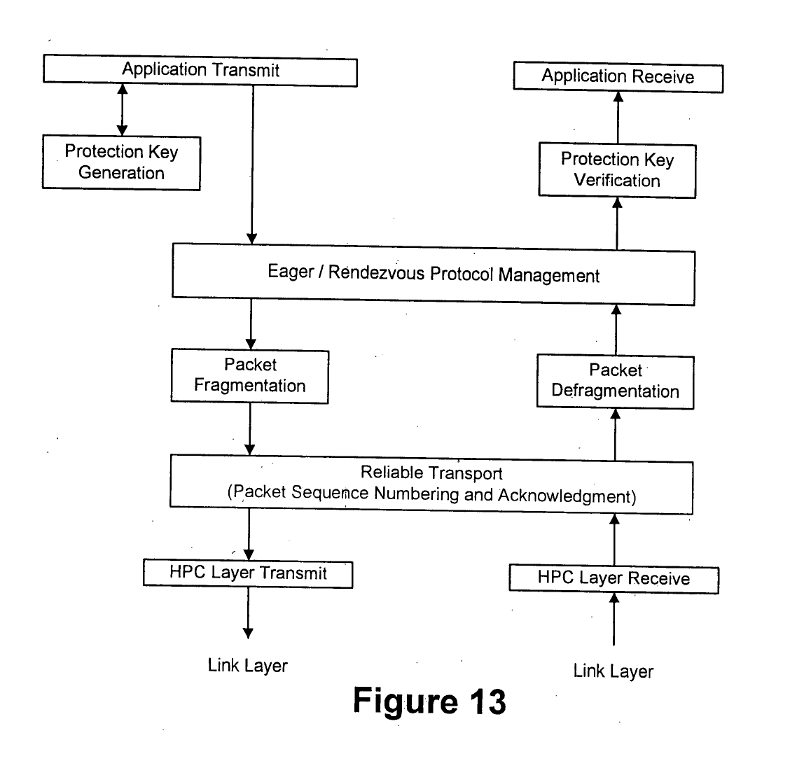

Network interface 630 implements the HPC protocol layer (see FIG. 13). Amongst other functions performed by the network interface, memory protection keys are generated for memory buffers that are to be exposed by receivers to senders. Memory protection keys are verified on receipt of messages. The network interface automatically selects and manages the eager and rendezvous protocols based on message size. Packets are fragmented and defragmented as needed to ensure that they fit within the link layer MTU size. The network interface ensures that messages are reliably transmitted and received.

As will be apparent to those skilled in the art, FIGS. 11, 12, and 13 are illustrative in nature. There are many different ways in which the functions of a network interface can be organized in order to get an equivalent result. Network interfaces according to the invention may not provide all of these functions or may provide additional functions.

In a preferred embodiment of the invention, network interface 630 is implemented as an integrated circuit (e.g. ASIC, FPGA) for maximum throughput and minimum latency. Network interface 630 directly implements a subset or all of the protocols of packetized interconnect 640 in hardware for maximum performance. Network interface 630 directly implements a subset or all of the protocols of communication data link 650 in hardware for maximum performance. Network interface 630 may implement the InfiniBand™ physical layer, the InfiniBand™ link layer, and the HPC protocol in hardware. Application level protocols are typically implemented in software but may be implemented in hardware in appropriate cases.

CPUs 610 and 710 use memory access semantics to interact with network interfaces 630 and 730. CPU 610 can send a message in one of two ways. It can either write the message directly to address space that is dedicated to network interface 630. This will direct the message over packetized interconnect 640 to network interface 630 where it can be transmitted over communication network 30.

In the alternative a message may be stored in memory 600. CPU 610 can cause network interface 630 to send the message by writing the address of the message in memory 600 and the length of the message to network interface 630. Network interface 630 can use DMA techniques to retrieve the message from memory 600 for sending at the same time as CPU 610 proceeds to do something else. For receipt of long messages under the rendezvous protocol, CPU 710 writes the address and length of application buffers to network interface 730. Both CPUs 610 and 710 write directly to network interfaces 630 and 730 to initialize and configure them.

Where a component (e.g. a software module, CPU, interface, node, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof.

1. A method for communicating data from a first compute node of a computer system comprising multiple compute nodes interconnected by an inter-node communication network to a second one of the multiple compute nodes, the method comprising:
placing the data on a full-duplex packetized interconnect directly connecting a CPU of the first compute node to a network interface connected to the inter-node communication network;
receiving the data at the network interface; and,
transmitting the data to a network interface of the second compute node by way of the inter-node communication network.

2. A method according to claim 1 wherein the network interface and the CPU are the only devices configured to place data on the packetized interconnect.

3. A method according to claim 1 comprising transmitting the data from the network interface to the second computer node by way of a full-duplex communication link of the inter-node communication network.

4. A method according to claim 3 comprising passing the data through a buffer at the network interface before transmitting the data.

5. A method according to claim 1 comprising, at the network interface, determining a size of the data and, based upon the size of the data, selecting among two or more protocols for transmitting the data.

6. A method according to claim 5 wherein the two or more protocols comprise an eager protocol and a rendezvous protocol.

7. A method according to claim 6 comprising, upon selecting the rendezvous protocol, automatically generating a Ready To Send message at the network interface of the first compute node.

8. A method according to claim 1 wherein the data comprises a raw ethertype datagram and transmitting the data comprises encapsulating the raw ethertype datagram within one or more link layer packet headers.

9. A method according to claim 8 wherein the link layer packet headers comprise InfiniBand™ link layer packet headers.

10. A method according to claim 1 wherein the data comprises a raw internet protocol datagram and transmitting the data comprises encapsulating the internet protocol datagram within one or more link layer packet headers.

11. A compute node for use in a multi-compute-node computer system; the compute node comprising:
a CPU;
a network interface; and,
a dedicated full-duplex packetized interconnect directly coupling the CPU to the network interface.

12. A compute node according to claim 11 wherein the dedicated packetized full-duplex interconnect is not shared by any devices other than the CPU and the network interface.

13. A compute node according to claim 11 comprising a memory, and a facility configured to allocate eager protocol buffers in the memory and to automatically signal to one or more other compute nodes that the eager protocol buffers have been allocated.

14. A compute node according to claim 13 comprising a facility configured to automatically associate memory protection keys with the eager protocol buffers and a facility configured to verify memory protection keys in incoming eager protocol messages before writing the incoming eager protocol messages to the eager protocol buffers.

15. A compute node according to claim 11 wherein the network interface comprises a hardware facility at the interface configured to encapsulate data received on the packetized interconnect in link layer packet headers.

16. A compute node according to claim 11 wherein the network interface comprises a buffer connected to buffer outgoing data.

17. A compute node according to claim 11 comprising a plurality of CPUs each connected to the interface by a separate dedicated full-duplex packetized interconnect.

18. A compute node according to claim 11 wherein the CPU is connected to each of a plurality of network interfaces by a plurality of dedicated full-duplex packetized interconnects.

19. A compute node according to claim 11 wherein the network interface comprises a facility configured to determine a size of data to be transmitted to another compute node and, based upon the size, to select among two or more protocols for transmitting the data to the other compute node.

20. A computer system comprising a plurality of compute nodes according to claim 11 interconnected by an inter-node data communication network, the inter-node data communication network providing at least one full-duplex data link to the network interface of each of the nodes.
